(19) United States
(12) Patent Application Publication
(10) Pub. No.: US 2012/0019539 A1
(43) Pub. Date: Jan. 26, 2012

(54) RENDERING APPARATUS, RENDERING METHOD AND COMPUTER READABLE MEDIUM

(75) Inventor: Yoshiyuki KOKOJIMA, Kanagawa-ken (JP)

(73) Assignee: KABUSHIKI KAISHA TOSHIBA, Tokyo (JP)

(21) Appl. No.: 13/017,541

(22) Filed: Jan. 31, 2011

(30) Foreign Application Priority Data
Jul. 20, 2010 (JP) 2010-163012

(51) Int. Cl. G06T 11/00

(52) U.S. Cl. 345/470

(57) ABSTRACT

According to one embodiment, an input unit inputs text data. An existence rank database stores an existence rank of each character included in the text data. The existence rank is a statistical rank of the number of each character among the number of all characters included in the text data. A decision unit decides whether the existence rank of each character of the text data is higher than a predetermined rank, by referring to the existence rank database. A texture generation unit generates a texture of a character having the existence rank higher than the predetermined rank, by using outline data of the character. A texture rendering unit renders the texture. A polygon generation unit generates a polygon mesh of a character having the existence rank lower than the predetermined rank, by using outline data of the character. A polygon rendering unit renders the polygon mesh.

### CROSS-REFERENCE TO RELATED APPLICATION

This application is based upon and claims the benefit of priority from Japanese Patent Application No. 2010-163012, filed on Jul. 20, 2010; the entire contents of which are incorporated herein by reference.

### FIELD

Embodiments described herein relate generally to a rendering apparatus, a rendering method and a computer readable medium.

### BACKGROUND

By using a graphics processing unit (GPU), a rendering apparatus to render a character image from outline data of a character is well known, for example, in following three references. As to this rendering apparatus, the character image is generated by rendering polygon meshes representing a shape of the character. Alternatively, the character image is generated by texture-mapping.

As to rendering processing from the polygon meshes, the memory-consumption is small, but the processing cannot be executed quickly. On the other hand, as to rendering processing by texture-mapping, the processing can be executed quickly, but a consumption quantity of the memory becomes large.

Briefly, in such rendering apparatus, one able to quickly render the character image with the small memory-consumption.

[Reference 1] JP-A 2007-272335 (Kokai)

[Reference 2] JP-A 2007-241878 (Kokai)

[Reference 3] C. Loop and J. Blinn, “Resolution Independent Curve Rendering using Programmable Graphics Hardware”, In Proceedings of ACM SIGGRAPH 2005, pp. 1000-1009

### BRIEF DESCRIPTION OF THE DRAWINGS

FIG. 1 is a block diagram of a rendering apparatus according to a first, embodiment.

FIG. 2 is one experimental result for the first embodiment.

FIG. 3 is another experimental result for the first embodiment.

FIG. 4 is a flow chart of processing of the rendering apparatus according to the first embodiment.

FIG. 5 is one example of existence rank data of characters according to the first embodiment.

FIG. 6 is one example of a polygon mesh according to the first embodiment.

FIG. 7 is one example of texture mapping according to the first embodiment.

FIG. 8 is a block diagram of the rendering apparatus according to a second embodiment.

### DETAILED DESCRIPTION

In general, according to one embodiment, a rendering apparatus includes an input unit, an existence rank database, a decision unit, a texture generation unit, a texture rendering unit, a polygon generation unit, and a polygon rendering unit. The input unit is configured to input text data. The existence rank database is configured to store an existence rank of each character included in the text data. The existence rank is a statistical rank of the number of each character among the number of all characters included in the text data. The decision unit is configured to decide whether the existence rank of each character of the text data is higher than a predetermined rank, by referring to the existence rank database. The texture generation unit is configured to generate a texture of a character having the existence rank higher than the predetermined rank, by using outline data of the character. The texture rendering unit is configured to render the texture. The polygon generation unit is configured to generate a polygon mesh of a character having the existence rank lower than the predetermined rank, by using outline data of the character. The polygon rendering unit is configured to render the polygon mesh.

Hereinafter, embodiments of the present invention will be explained by referring to the drawings. The present invention is not limited to the following embodiments.

### The First Embodiment

A rendering apparatus of the first embodiment is used for a television (TV) or a recorder to display an electronic program guide (EPG). In the rendering apparatus 1, as to a plurality of characters included in the electronic program guide, an image (character image) of each character is rendered (drawn) from any of a polygon mesh and a texture, based on “existence rank” statistically ranking the number of each character included in the electronic program guide.

In the rendering apparatus 1, as to a character of which existence rank is equal to or lower than a predetermined rank, the character image is rendered from a polygon mesh. As to a character of which existence rank is higher than a predetermined rank, the character image is rendered from a texture.

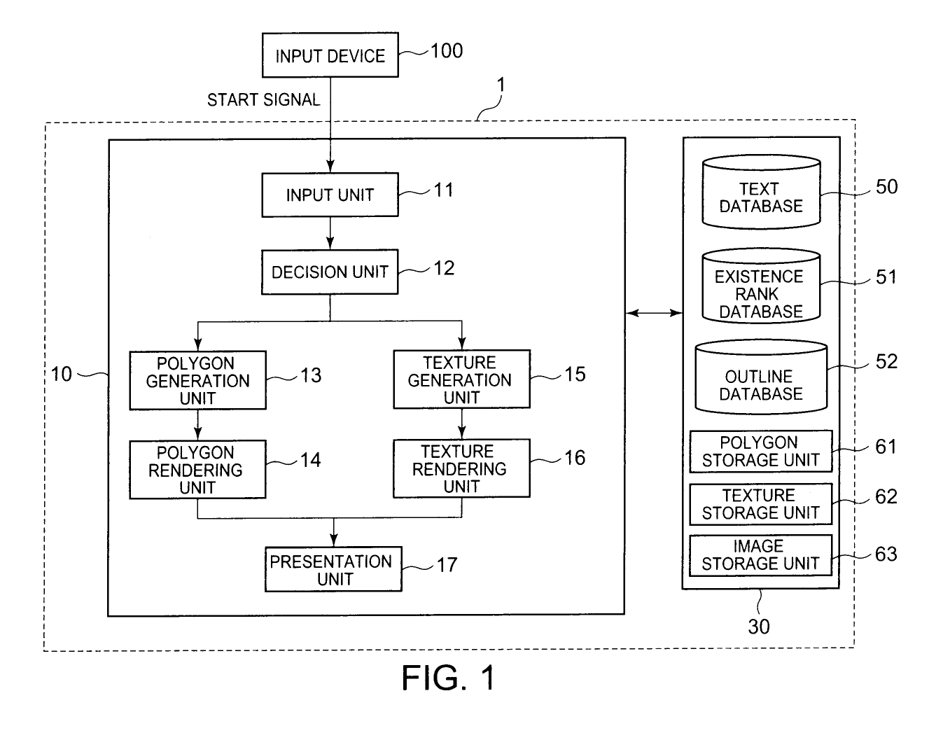

As shown in FIG. 1, the rendering apparatus 1 includes a processing unit 10 and a storage unit 30. The processing unit 10 includes an input unit 11, a decision unit 12, a polygon generation unit 13, a polygon rendering unit 14, a texture generation unit 15, a texture drawing unit 16, and a presentation unit 17. The storage unit 30 includes a text database 50, an existence rank database 51, an outline database 52, a polygon storage unit 61, a texture storage unit 62, and an image storage unit 63. The text database 50, the existence database 51, and the outline database 52, may be stored in an external device (used by the rendering apparatus 1).

The processing unit 10 may be realized by a CPU or a GPU. The storage unit 30 may be realized by a memory (used by the CPU or the GPU). For example, the input unit 11, the decision unit 12, the polygon generation unit 13, and the texture generation unit 15, may be realized by the CPU. The polygon rendering unit 14 and the texture rendering unit 16 can be realized by the GPU. Furthermore, in the storage unit 30, at least one of the text database 50, the existence rank database 51, the outline database 52, the polygon storage unit 61, the texture storage unit 62 and the image storage unit 63, may be realized by an auxiliary storage device (used by the CPU or the GPU).

The text database 50 stores text data (character strings) of the electronic program guide. The existence database 51 stores existence data representing correspondence between a number (character number) peculiar to each character (such as hiragana, katakana, alphabet, numeral) and an existence rank. The outline database 52 stores outline data representing a boundary shape of each character.

The input device 100 outputs a start signal to start acquisition of text data of the electronic program guide to the input unit 11. For example, the input device 100 may be a remote controller of TV (television). In response to the start signal, the input unit 11 inputs the text data of the electronic program guide from the text database 50, and supplies each character of the text data to the decision unit 12.

The decision unit 12 decides whether each character (included in the text data) is higher than a predetermined rank by referring to the existence rank database 51. If an existence rank of the character is equal to, or lower than the predetermined rank, the decision unit 12 outputs the character to the polygon generation unit 13. If the existence rank of the character is higher than the predetermined rank, the decision unit 12 outputs the character to the texture generation unit 15.

The polygon generation unit 13 acquires outline data of the character (output from the decision unit 12) from the outline database 52. The polygon generation unit 13 generates a polygon mesh from the outline data acquired. The polygon rendering unit 14 renders (draws) a character image by filling the polygon mesh.

The texture generation unit 15 acquires outline data of the character (output from the decision unit 12) from the outline database 52. The texture generation unit 15 generates a bitmap image (texture) from the outline data acquired. The texture rendering unit 16 renders (draws) a character image by mapping the texture onto a quad polygon.

The presentation unit 17 presents the character image rendered by the polygon rendering unit 14 or the texture rendering unit 16. In this way, the electronic program guide is presented to a user. Next, the existence rank stored by the existence rank database 51 is explained.

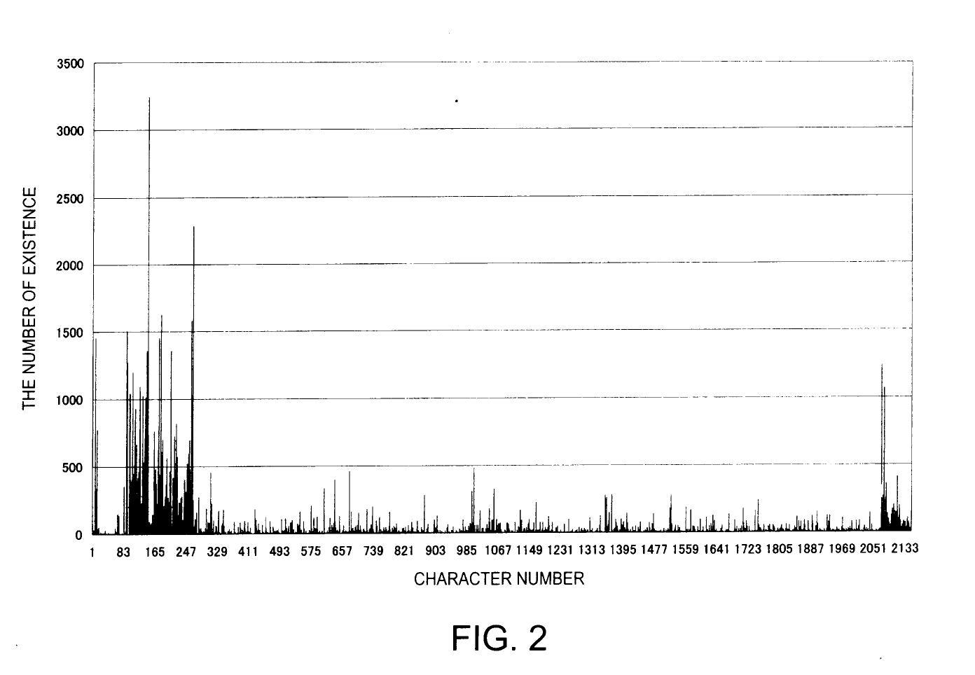

FIG. 2 is a graph of experimental result of the counted number (the number of existence) of each character included in the electronic program guide of ground-based digital broadcasting (seven channels) for one week. In FIG. 2, a horizontal axis represents a character number, and a vertical axis represents the number of existence. For example, the character number “105” indicates Japanese hiragana “ [symbol] ” of a capital letter, and the character number “311” indicates a Chinese character “ [symbol] ” (its meaning is a person).

As shown in FIG. 2, characters of which the number of existence is large and characters of which the number of existence is small exist in the electronic program guide. For example, the number of existence of Japanese hiragana “ [symbol] ” of character number “146” is “3244”, the number of existence of Japanese katakana “ [symbol] ” of character number “215” is “1”, and the number of existence of alphabet “f” of a small letter of character number “3120” is “2”.

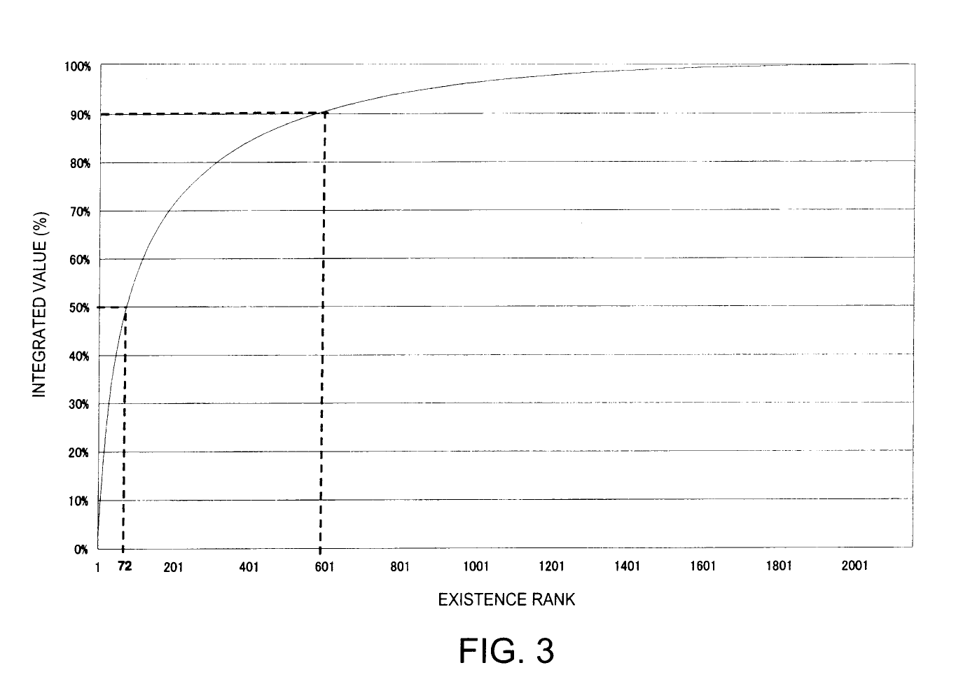

FIG. 3 is a graph representing a bias of the number of existence of character. Briefly, FIG. 3 is the graph acquired from the same experimental result as FIG. 2, but definition of the axis is different from FIG. 1. In FIG. 3, the horizontal axis represents the number of existence. The vertical axis represents, by integrating the number of existence of each character in order from a character having the number of existence “1”, a percentage (it is called “integrated ratio”) of an integrated value of each character to the number of existence of all characters. For example, as to an existence rank “1001” (along the horizontal axis), an integrated value (along the vertical axis) represents a percentage of an integrated value of the number of existence of each character from “1” to “1001” (the existence rank) to the number of existence of all characters. As shown in FIG. 3, the existence number of characters from “1” to “72” (the existence rank) occupies 50% of the number of existence of all characters. As above-mentioned, the existence rank is explained.

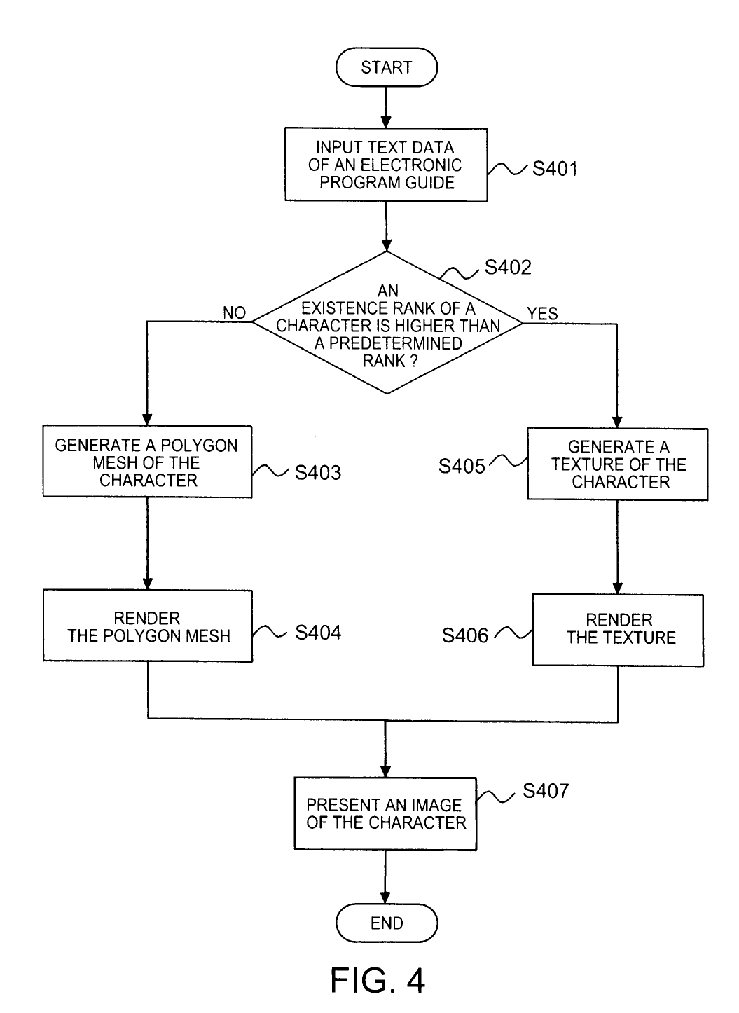

As shown in a flow chart of FIG. 4, in response to a start signal, the input unit 11 inputs text data of an electronic program guide from the text database 50, and supplies each character of the text data to the decision unit 12 in order (S401). By referring to the existence rank database 51, the decision unit 12 decides whether an existence rank of each character (included in the text data) is higher than a predetermined rank (S402).

In case of “NO” at S402, the decision unit 12 outputs the character to the polygon generation unit 13. The polygon generation unit 13 acquires outline data of the character (output from the decision unit 12) from the outline database 52. The polygon generation unit 13 generates a polygon mesh from the outline data (S403). By filling the polygon mesh, the polygon rendering unit 14 renders a character image (S404).

In case of “YES” at S402, the decision unit 12 outputs the character to the texture generation unit 15. The texture generation unit 15 acquires outline data of the character (output from the decision unit 12) from the outline database 52. The texture generation unit 15 generates a bitmap image (texture) from the outline data (S405). By mapping the texture onto a quad polygon, the texture rendering unit 16 renders a character image (S406).

The presentation unit 17 presents the character image rendered by the polygon rendering unit 14 or the texture rendering unit 16 (S407). As above-mentioned, processing of the rendering apparatus 1 is explained by referring to the flow chart. Next, each unit of the rendering apparatus 1 is explained in detail.

In response to the start signal from the input device 100, the input unit 11 inputs text data of the electronic program guide from the text database 50. If the rendering apparatus 1 is used for TV, the input device 100 may be a remote controller. In this case, a user pushes a button (set on the input device 100) to display the electronic program guide. By this operation, the start signal to start acquisition of text data of the electronic program guide is output from the input device 100 to the input unit 11.

Furthermore, the input unit 11 had better acquire text data of which electronic program guide can be displayed at once as stillness image, from the text database 50. In response to the start signal, the input unit 11 inputs text data of the electronic program guide from the text database 50, and supplies each character of the text data to the decision unit 12. For example, if the text data acquired by the input unit 11 from the text database 50 is “A B C [symbol] 3” (in Japanese), the input unit 11 supplies the text data “A B C [symbol] 3” to the decision unit 12 in order.

By referring to the existence rank database 51, the decision unit 12 decides whether an existence rank of each character (included in the text data) is higher than a predetermined rank. For example, as to each character included in “A B C [symbol] 3”, the decision unit 12 decides whether the existence rank of each character is higher than the predetermined rank by referring to the existence rank database 51.

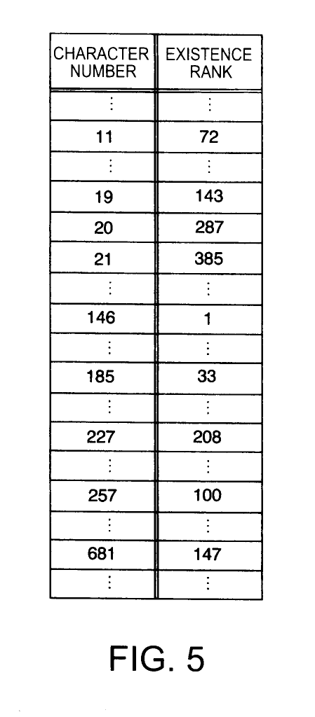

FIG. 5 shows one example of character rank data stored in the existence rank database 51. As mentioned-above, the existence rank database 51 stores correspondence data (existence rank data) between a character number and the existence rank. For example, the existence rank of a numeral “3” of the character number 11 is 72, the existence rank of Japanese katakana “ [symbol] ” of the character number 185 is 33, and the existence rank of Chinese kanji “ [symbol] ” of the character number 681 is 147.

In the first embodiment, the predetermined rank may be previously determined. For example, if a capacity of the storage unit is 4 MB in which 1 MB is used by the texture generation unit 15, the predetermined rank may be approximately “150”. In this example, the predetermined rank is set as “150”.

If it is decided that the existence rank of the character is higher than the predetermined rank, the decision unit 12 outputs the character to the texture generation unit 15. If it is decided that the existence rank of the character is equal to or lower than the predetermined rank, the decision unit 12 outputs the character to the polygon generation unit 13.

For example, as to the text data “A B C [symbol] ”, by referring to the existence rank database 51, existence ranks of “B”, “C” and “ [symbol] ” are respectively lower than the predetermined rank “150”. Accordingly, the decision unit 12 outputs the text data of “B”, “C” and “ [symbol] ” to the polygon generation unit 13. On the other hand, existence ranks of “A”, “ [symbol] ”, “ [symbol] ”, “ [symbol] ” and “ [symbol] ” are respectively higher than the predetermined rank “150”. Accordingly, the decision unit 12 outputs the text data of “A”, “ [symbol] ”, “ [symbol] ”, “ [symbol] ” and “ [symbol] ” to the texture generation unit 15.

The polygon generation unit 13 acquires outline data of each character (output from the decision unit 12) from the outline database 52. The polygon generation unit 13 generates a polygon mesh from the outline data.

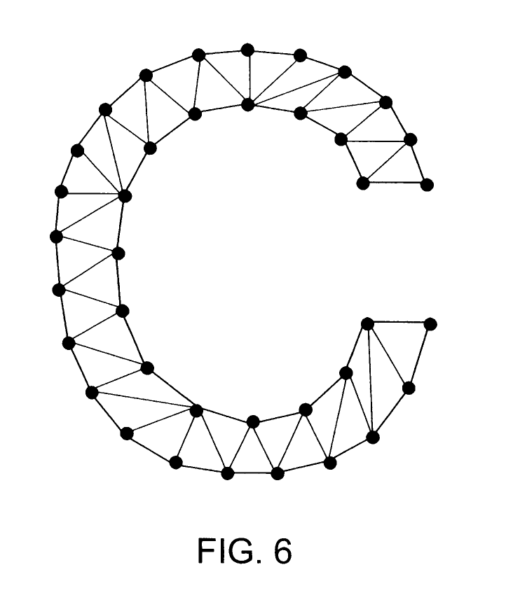

FIG. 6 is one example of the polygon mesh generated by the polygon generation unit 13. In this example, the polygon generation unit 13 generates a polygon mesh from outline data “C”. As shown in FIG. 6, the polygon generation unit 13 may divide the inside of a boundary “C” into triangular polygon meshes. By this processing, the polygon generation unit 13 may generate a polygon mesh of “C”. Alternatively, the polygon generation unit 13 may generate a polygon mesh by the method disclosed in Reference 2.

In this example, the polygon generation unit 13 acquires outline data of “B”, “C” and “ [symbol] ” from the outline database 52, and generates a polygon mesh of each character. The polygon generation unit 13 writes the polygon mesh into the polygon storage unit 61. When this write processing is completed, the polygon generation unit 13 outputs a notice signal representing write-completion to the polygon rendering unit 14.

The polygon rendering unit 14 reads the polygon mesh from the polygon storage unit 61. By filling the polygon mesh of each character, the polygon rendering unit 14 renders a character image. For example, by using the method disclosed in the Reference 1, the polygon rendering unit 14 may fill the polygon mesh. The polygon rendering unit 14 writes the character image (rendered by filling the polygon mesh) into the image storage unit 63.

The texture generation unit 15 acquires outline data of the character (output from the decision unit 12) from the outline database 52. The texture generation unit 15 generates a bitmap image (texture) of the character from the outline data. For example, by using the method disclosed in the Reference 2 or 3, the texture generation unit 15 may generate a texture. In this example, the texture generation unit 15 generates textures of “A”, “ [symbol] ”, “ [symbol] ”, “ [symbol] ” and “ [symbol] ”.

The texture generation unit 15 generates quad polygons on which textures are mapped, as the number of textures. The texture generation unit 15 writes textures and quad polygons into the texture storage unit 62. When write-processing is completed, the texture generation unit 15 outputs a notice signal representing write-completion to the texture rendering unit 16.

The texture rendering unit 16 reads textures and quad polygons from the texture storage unit 62. By mapping the texture onto the quad polygon, the texture rendering unit 16 renders a character image, and writes the character image into the image storage unit 63.

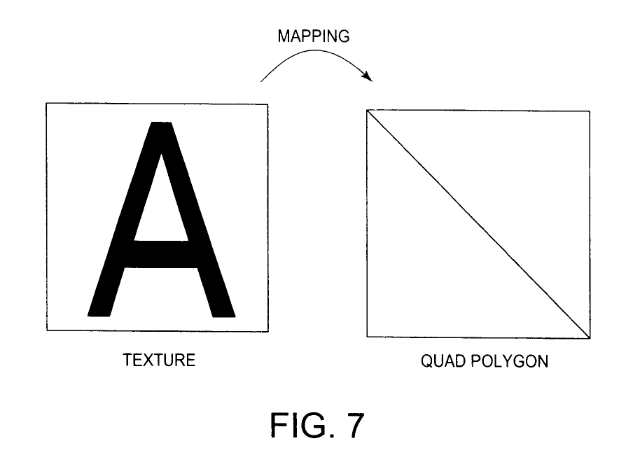

FIG. 7 is one example of a texture and a quad polygon generated by the texture generation unit 15. As shown in FIG. 7, by mapping a texture “A” onto the quad polygon, the texture generation unit 15 renders a character image “A”.

When rendering of all character images is completed, each of the polygon rendering unit 14 and the texture rendering unit 16 outputs a notice signal representing rendering-completion to the presentation unit 17. The presentation unit 17 reads character images (rendered by the polygon rendering unit 14 and the texture rendering unit 16) from the image storage unit 63. The presentation unit 17 presents the character image read. For example, the presentation unit 17 may be a display device or a printer device.

As mentioned-above, in the first embodiment, as to characters of which the number of existence is large in the electronic program guide, rendering is executed using textures. As to characters of which the number of existence is small in the electronic program guide, rendering is executed using polygon meshes.

In the first embodiment, by reducing the number of polygon meshes necessary for rendering, clear character images can be quickly rendered with small memory-consumption.

Briefly, characters having an existence rank higher than a predetermined rank are rendered by texture-mapping, and other characters are rendered by polygon-filling. As a result, the memory-consumption can be reduced. Furthermore, as to characters having the existence rank higher than the predetermined rank, they can be rendered with four peaks of quad polygons. Accordingly, the number of polygon meshes thereof can be reduced.

Moreover, in the first embodiment, the existence rank database 51 may not necessarily store existence rank data of all characters counted by above-mentioned experimentation. For example, existence rank data of characters having existence rank from “1” to “1500” may be stored. Furthermore, the existence rank database 51 may store characters to be output to the texture generation unit 15 by the decision unit 12. In this case, by referring to the existence rank database 51, the decision unit 12 may output characters included in the existence rank database 51 to the texture generation unit 15, and output characters not included in the existence rank database 51 to the polygon generation unit 13.

In the first embodiment, the texture generation unit 15 generates textures from outline data. However, the texture generation unit 15 may previously generate textures of characters having existence rank higher than a predetermined rank, and write them into the texture storage unit 62.

Furthermore, the texture generation unit 15 may write a character image (texture) created once, into the storage unit 30. After that, when the same character (text data) as the character image (stored in the storage unit 30) is output from the decision unit 12, the texture generation unit 15 may read the character image (texture) from the storage unit 30. In this case, the processing cost of the texture generation unit 15 can be suppressed.

Furthermore, in the first embodiment, as to a character having existence rank equal to a predetermined rank, the decision unit 12 outputs the character to the polygon generation unit 13. However, the decision unit 12 may output this character to the texture generation unit 15. In this case, at S402 in FIG. 4, the decision unit 12 decides whether an existence rank of each character (included in the text data) is equal to or higher than a predetermined rank.

In the first embodiment, a television (TV) or a recorder to display an electronic program guide (EPG) is explained as one example. However, the example is not limited to them. For example, the rendering apparatus 2 can be applied to an electronic book terminal to read/display electronic book stored. In this case, the text database 50 may store text data for the electronic book.

### The Second Embodiment

As to the second embodiment, a rendering apparatus 2 changes a predetermined rank used for decision (by the decision unit 12), based on free capacity of the storage unit 30.

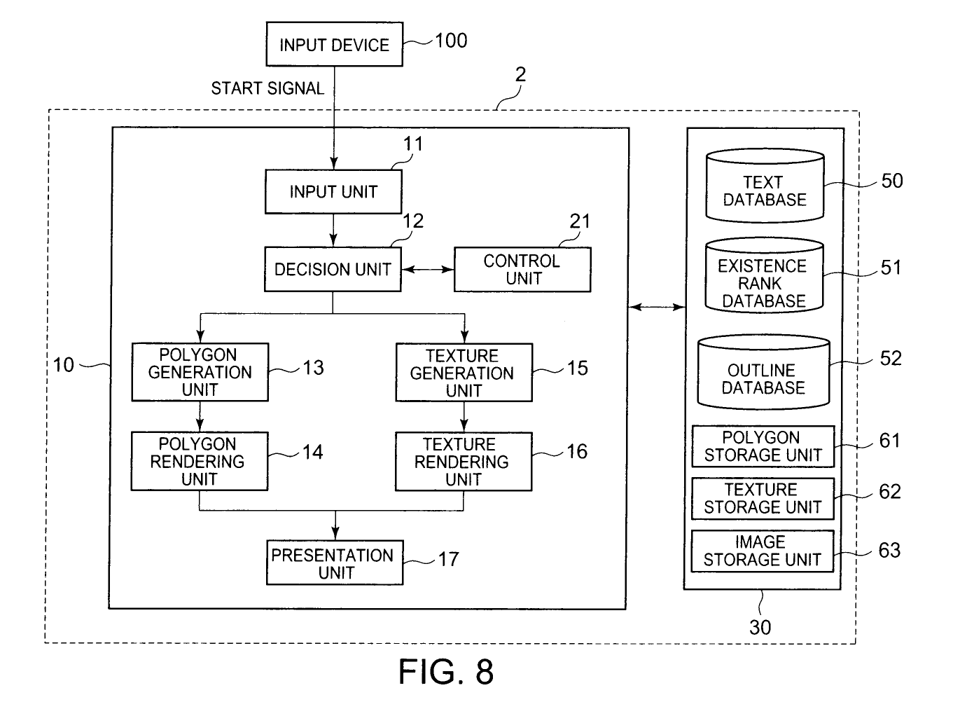

As shown in FIG. 8, in comparison with the rendering apparatus 1 of the first embodiment, the rendering apparatus 2 further includes a control unit 21. The control unit 21 may be realized by a CPU.

The control unit 21 controls (checks) a free capacity of the storage unit 30. When the free capacity is larger than a threshold, the control unit 21 further lowers the predetermined rank (used by the decision unit 12). When the free capacity is equal to or smaller than the threshold, the control unit 21 further raises the predetermined rank (used by the decision unit 12).

For example, assume that the free capacity of the storage unit 30 is 10 MB and the predetermined rank is “500”. After that, when the free capacity of the storage unit 30 becomes 1 MB, the control unit 21 changes the predetermined rank as “50”.

As mentioned-above, in the second embodiment, based on the free capacity of the storage unit 30, it is decided whether character images are rendered from polygon meshes or textures. Accordingly, in the second embodiment, the storage unit 30 can be further effectively utilized.

Briefly, as to the first and second embodiments, character images can be quickly rendered with small memory-consumption.

In the disclosed embodiments, the processing can be performed by a computer program stored in a computer-readable medium.

In the embodiments, the computer readable medium may be, for example, a magnetic disk, a flexible disk, a hard disk, an optical disk (e.g., CD-ROM, CD-R, DVD), an optical magnetic disk (e.g., MD). However, any computer readable medium, which is configured to store a computer program for causing a computer to perform the processing described above, may be used.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the memory device is not limited to one. In the case that the processing of the embodiments is executed by a plurality of memory devices, a plurality of memory devices may be included in the memory device.

A computer may execute each processing stage of the embodiments according to the program stored in the memory device. The computer may be one apparatus such as a personal computer or a system in which a plurality of processing apparatuses are connected through a network. Furthermore, the computer is not limited to a personal computer. Those skilled in the art will appreciate that a computer includes a processing unit in an information processor, a microcomputer, and so on. In short, the equipment and the apparatus that can execute the functions in embodiments using the program are generally called the computer.

While certain embodiments have been described, these embodiments have been presented by way of examples only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A rendering apparatus comprising:
an input unit configured to input text data;
an existence rank database configured to store an existence rank of each character included in the text data, the existence rank being a statistical rank of the number of each character among the number of all characters included in the text data;
a decision unit configured to decide whether the existence rank of each character of the text data is higher than a predetermined rank, by referring to the existence rank database;
a texture generation unit configured to generate a texture of a character having the existence rank higher than the predetermined rank, by using outline data of the character;
a texture rendering unit configured to render the texture;
a polygon generation unit configured to generate a polygon mesh of a character having the existence rank lower than the predetermined rank, by using outline data of the character; and
a polygon rendering unit configured to render the polygon mesh.

2. The apparatus according to claim 1, further comprising:
a storage unit configured to store the texture and the polygon mesh; and
a control unit configured to control a free capacity of the storage unit;
wherein the control unit changes the predetermined rank to a lower rank when the free capacity becomes larger, and changes the predetermined rank to a higher rank when the free capacity becomes smaller.

3. The apparatus according to claim 2, further comprising:
an outline database configured to store outline data of each character;
wherein the texture generation unit acquires outline data of a character from the outline database, and generates the texture of the character by using the outline data, and
wherein the polygon generation unit acquires outline data of a character from the outline database, and generates the polygon mesh of the character by using the outline data.

4. The apparatus according to claim 3, further comprising:
a text database configured to store the text data to be input by the input unit;
wherein the existence rank of each character is determined from the highest rank in larger order of the number of each character included in the text data.

5. The apparatus according to claim 1, further comprising:
a presentation unit configured to present the texture rendered by the texture rendering unit and the polygon mesh rendered by the polygon rendering unit.

6. A rendering method comprising:
inputting text data;
storing in an existence rank database, an existence rank of each character included in the text data, the existence rank being a statistical rank of the number of each character among the number of all characters included in the text data;
deciding whether the existence rank of each character of the text data is higher than a predetermined rank, by referring to the existence rank database;
generating a texture of a character having the existence rank higher than the predetermined rank, by using outline data of the character;
rendering the texture;
generating a polygon mesh of a character having the existence rank lower than the predetermined rank, by using outline data of the character; and
rendering the polygon mesh.

7. A computer readable medium storing a computer program for causing a computer to perform a rendering method, the method comprising:
inputting text data;
storing in an existence rank database, an existence rank of each character included in the text data, the existence rank being a statistical rank of the number of each character among the number of all characters included in the text data;
deciding whether the existence rank of each character of the text data is higher than a predetermined rank, by referring to the existence rank database;
generating a texture of a character having the existence rank higher than the predetermined rank, by using outline data of the character;
rendering the texture;
generating a polygon mesh of a character having the existence rank lower than the predetermined rank, by using outline data of the character; and
rendering the polygon mesh.
